(19) United States
(12) Patent Application Publication
(10) Pub. No.: US 2024/0327554 A1
(43) Pub. Date: Oct. 3, 2024

(54) COMPOSITIONS AND METHODS FOR MAKING A REVERSIBILY-CROSSLINKED POLYMER

(71) Applicant: BRASKEM AMERICA, INC., Philadelphia, PA (US)

(72) Inventors: Sarah Mitchell, Pittsburgh, PA (US); Hadi Mohammadi, Pittsburgh, PA (US); Kimberly Miller McLoughlin, Pittsburgh, PA (US)

(21) Appl. No.: 18/621,652

(22) Filed: Mar. 29, 2024

Related U.S. Application Data
(60) Provisional application No. 63/456,068, filed on Mar. 31, 2023.

(51) Int. Cl. C08F 210/02

(52) U.S. Cl. CPC C08F 210/02; C08F 2800/20; C08F 2810/20

(57) ABSTRACT

The invention relates to a polymerizable composition, comprising a crosslinker comprising a —Sₙ- moiety and having at least two polymerizable groups, wherein n is an integer of from 2 to 8; one or more monomers, each monomer having at least one C═C double bond capable of undergoing a polymerization reaction; and a polymerization initiator. The invention also relates to methods of making a reversibly-crosslinked polymer by reacting the components of the polymerizable composition, and the resulting reversibly-crosslinkable polymer and its reprocessing/recycling.

### CROSS-REFERENCE TO RELATED APPLICATIONS

This application claims priority to U.S. Provisional Patent Application No. 63/456,068, filed Mar. 31, 2023, which is incorporated herein by reference in its entirety.

### FIELD OF THE INVENTION

This invention generally relates to the field of preparing reversibly-crosslinked polymers for reprocessing/recycling the polymers.

### BACKGROUND OF THE INVENTION

Conventional polymer networks, also known as thermosets, consist of permanent covalent crosslinks that make reprocessing and recycling these polymers impractical. Examples of conventional polymers networks produced in high pressure polymerizations are low density polyethylene (LDPE) and ethylene/VA copolymer (EVA).

Efforts have been made to incorporate inherently reversible crosslinks into a polymer network, allowing for the polymer networks to be reprocessed and recycled. However, a full recovery of crosslinks after multiple reprocessing steps is still challenging to the current technology.

There thus remains a continuous need in the art for developing novel crosslinking chemistry to obtain a reversibly-crosslinked polymer that is fully reprocessable and recyclable, while maintaining the properties of the original polymer.

### SUMMARY OF THE INVENTION

In one aspect, provided herein is a polymerizable composition, comprising a crosslinker comprising a —Sₙ- moiety and having at least two polymerizable groups, wherein n is an integer of from 2 to 8; one or more monomers, each monomer having at least one C═C double bond capable of undergoing a polymerization reaction; and a polymerization initiator.

In another aspect, provided herein is a method of making a reversibly-crosslinked polymer, comprising: reacting a crosslinker comprising a —Sₙ- moiety and having at least two polymerizable groups, wherein n is an integer of from 2 to 8, and one or more monomers, each monomer having at least one C═C double bond capable of undergoing a polymerization reaction, in the presence of the polymerization initiator, to produce a reversibly-crosslinked polymer that, when reprocessed at temperatures greater than 50°° C., dissociate the crosslinking bonds of the reversibly-crosslinked polymer.

Another aspect of the invention relates to a reversibly-crosslinkable polymer, comprising the reaction product of the polymerizable composition as described from the above aspect of the invention, wherein the reversibly-crosslinkable polymer contains a —S—S- moiety.

Another aspect of the invention relates to reversibly-crosslinkable polymer obtained according to the method as described from the above aspect of the invention.

Additional aspects, advantages and features of the invention are set forth in this specification, and in part will become apparent to those skilled in the art on examination of the following, or may be learned by practice of the invention. The inventions disclosed in this application are not limited to any particular set of or combination of aspects, advantages and features. It is contemplated that various combinations of the stated aspects, advantages and features make up the inventions disclosed in this application.

### BRIEF DESCRIPTION OF THE DRAWINGS

FIG. 1 is a scheme illustrating a reaction scheme for high pressure polymerization with a dynamic disulfide crosslinker (A), and examples of dynamic disulfide crosslinkers (B) according to the present invention.

FIGS. 2A-2B are DSC results of an exemplary reversibly crosslinked DSDMA/ethylene copolymer, wherein DSC chromatographs (FIG. 2A) and Te and Tm trend as crosslinker concentration increases (FIG. 2B).

FIGS. 3A-3B show the results of the storage modulus and tan delta of an exemplary reversibly crosslinked DSDMA/ethylene copolymer (FIG. 3A), as well as the swelling studies for such exemplary copolymer (FIG. 3B).

FIG. 4 shows the normalized results of the stress relaxation of an exemplary reversibly crosslinked DSDMA/ethylene copolymer.

FIG. 5 depicts the reprocessability study for one of the exemplary samples (A5).

### DETAILED DESCRIPTION OF THE INVENTION

The disclosure provides a polymerizable composition and method for making a reversibly-crosslinked polymer, employing a dynamic crosslinker that contains polymerizable groups allowing for its incorporation into a polymer network via polymerization and a reversible linkage that dissociates at an elevated temperature and reassociates when cooled down. This dynamic crosslinking produces polymer networks that are reversible and can be reprocessed and recycled.

### Polymerizable Composition

One aspect of the invention relates to a polymerizable composition, comprising a crosslinker comprising a —Sₙ-moiety and having at least two polymerizable groups, wherein n is an integer of from 2 to 8; one or more monomers, each monomer having at least one C═C double bond capable of undergoing a polymerization reaction; and a polymerization initiator.

The crosslinker is a dynamic crosslinker, meaning that the polymer chains of the polymers, formed from polymerization of the crosslinkers and the monomers, are covalently linked via a reversible linkage provided by the crosslinker that dissociates at an elevated temperature and reassociates upon cooling. The crosslinker also contains a polymerizable group allowing for its incorporation into a polymer network via polymerization.

The crosslinker comprises a —Sₙ- moiety (n is an integer of from 2 to 8, e.g., 2 or 3) and has at least two polymerizable groups. The dynamic nature comes from the disulfide or polysulfide bond that dissociates to form a stable thiyl radical upon heating, and reassociates back to reform the disulfide or polysulfide bond upon cooling down to room temperature. The polymerizable group can comprise an unsaturated bond capable of polymerization reaction to allow for incorporation of the crosslinker into a polymer network during polymerization reaction. For instance, the polymerizable group can comprise a C═C double bond. The two polymerizable groups may be the same or different.

The unsaturated bond (e.g., C═C double bond) capable of undergoing a polymerization reaction is in a functional group including but not limited to an alkene, an alkyne, a nitrile, vinyl group, an acyl, an acrylate, a (meth)acrylate, a styrene, and a vinyl pyridine.

In some embodiments, the crosslinker may be represented by Formula (I), (II), (III), (IV) or (V):

R¹R²R³C—Sₙ—CR⁴R⁵R⁶ (I)

R⁷—CH(X)—Sₙ—CH(Y)-R⁸ (II)

R⁷-B₁-A₁-Sₙ-A₂-B₂-R⁸ (III)

R¹⁵—O—Sₙ—O—R¹⁶ (IV)

(R¹⁷)(R¹⁸)-P—Sₙ—P-(R¹⁹)(R²⁰) (V).

Integer n is from 2 to 8, such as 2 or 5, 2 to 4, or 2 to 3. Typically, n is 2 or 3. In one embodiment, n is 2. In one embodiment, n is 3.

Each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹ and R²⁰ is independently a hydrogen atom, a halogen atom, a C₁₋₂₀ linear or branched alkyl, a C₂₋₂₀ alkenyl, a C₂₋₂₀ alkynyl, a nitrile, a hydroxyl, an ester having from 1 to 20 carbon atoms, an ether having from 1 to 20 carbon atoms, a thioether having from 1 to 20 carbon atoms, a ketone having from 1 to 20 carbon atoms, an imine, an amide, a primary amine, a secondary amine, a tertiary amine, a trifluoromethyl, a phenyl, a benzyl, a phenol, a pentafluorophenyl, a nitroxyl, or a silcone having from 1 to 20 carbon atoms. Each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹ and R²⁰ can be optionally substituted by one or more alkyl, alkenyl, hydroxyl, or halide groups. The optional substituents replace the hydrogen atom(s) of these R variables. Exemplary substituents are C₁-C₆ alkyl (linear or branched), C₂-C₆ alkenyl, hydroxyl, or halide groups.

X represents CHR⁹R¹⁰, OH, SH, or NHR¹¹. Y represents CHR¹²R¹³, OH, SH, or NHR¹⁴.

Each of A₁ and A₂ is independently absent, a C₁-C₂₀ alkylene, a C₂-C₂₀ cycloalkylene, a divalent form of C₂-C₂₀ alkene, a divalent form of C₂-C₂₀ alkyne, an arylene, or combinations thereof; each optionally substituted by one or more alkyl, alkenyl, hydroxyl, or halogen atoms.

Each of B¹ and B² is independently absent or a divalent form of imine, amine, carbonyl, amide, ether, or ester, or combinations thereof.

The term “divalent form” refers to a divalent radical that is formed when a hydrogen atom is removed from a functional group, e.g., a radical of alkyl, alkenyl, cycloalkyl, or alkynyl, etc., or when terminal hydrogen atoms are removed from a hydrocarbon, e.g., an alkane, alkene, cycloalkane, or alkyne, etc. For instance, in the case of divalent form of alkene (alkenylene), the term refers to a divalent radical that has hydrogen atoms removed from each of the two terminal carbon atoms of the alkene chain. A divalent form of a moiety is defined to represent the moiety present in the middle of a structural formula, with each end of the moiety bonding to another moiety, bond, or hydrogen atom.

In some embodiments, the crosslinker is represented by Formula (I). In Formula (I), at least one of R¹, R², and R³ comprises a C═C double bond and at least one of R⁴, R⁵, and R⁶ comprise a C═C double bond. R¹, R², R³, R⁴, R⁵, and R⁶ may be the same or different. (R¹R²R³) and (R⁴R⁵R⁶) may be the same or different. In some embodiments, each of R¹ and R⁴ is H; each of R² and R⁵ may be H or alkyl, and each of R³ and R⁶ comprises a C═C double bond. In some embodiments, each of R³ and R⁶ independently comprises an alkene, an alkyne, a nitrile, an acyl, an acrylate, a (meth)acrylate, a styrene, or a vinyl pyridine.

In some embodiments, the crosslinker is represented by Formula (II). In Formula (II), each of R⁷ and R⁸ comprises a C═C double bond. X and Y may be the same or different. R⁷ and R⁸ may be the same or different. R⁷—CH(X)- and —CH(Y)—R⁸ may be the same or different. In some embodiments, each of X and Y independent represents CHR⁹R¹⁰, OH, SH, or NHR¹¹, wherein each of R⁹, R¹⁰, and R¹¹ is independently H or alkyl. In some embodiments, each of X and Y independent represents CHR⁹R¹⁰ or NHR¹¹, wherein each of R⁹, R¹⁰, and R¹¹ is independently H or methyl. In some embodiments, each of R⁷ and R⁸ independently comprises an alkene, an alkyne, a nitrile, an acyl, an acrylate, a (meth)acrylate, a styrene, or a vinyl pyridine.

In some embodiments, the crosslinker is represented by Formula (III). In Formula (III), each of R⁷ and R⁸ comprises a C═C double bond. A₁ and A₂ may be the same or different. B₁ and B₂ may be the same or different. R⁷ and R⁸ may be the same or different. R⁷-B₁-A₁- and -A₂-B₂-R⁸ may be the same or different. In some embodiments, each of A₁ and A₂ is independently absent, a C₁-C₅ alkylene, a C₂-C₆ cycloalkylene, or a phenylene; each optionally substituted by one or more alkyl, hydroxyl, or halogen atoms. In some embodiments, each of B₁ and B₂ is independently absent or a divalent form of amine, amide, or ester. In some embodiments, each of R⁷ and R⁸ is independently a C₂-C₆ alkenyl, optionally substituted by one or more C₁-C₃ alkyl. In some embodiments, each of R⁷ and R⁸ is independently a unsubstituted C₂-C₆ alkenyl. In some embodiments, each of R⁷ and R⁸ is independently comprises a C₂-C₆ alkynyl optionally substituted by one or more C₁-C₃ alkyl or a nitrile.

In some embodiments, the crosslinker is represented by (III), wherein n is 2 or 3; each of R⁷ and R⁸ is independently a C₂-C₂₀ alkenyl, optionally substituted by one or more alkyl or alkenyl; each of A₁ and A₂ is independently absent, a C₁-C₂₀ alkylene or a divalent form of phenyl; each optionally substituted by one or more alkyl, alkenyl, hydroxyl, or halogen atoms; each of B¹ and B² is independently absent or a divalent form of amine, amide, ether, or ester.

In some embodiments, the crosslinker has the structure of formula:

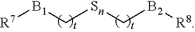

The integer n is 2 or 3. In one embodiment, n is 2. In one embodiment, n is 3. The integer t is 1 to 5, for instance 1 to 4, or 1 to 3. In one embodiment, t is 1. In one embodiment, t is 2. In one embodiment, t is 3. Each of R⁷ and R⁸ is independently a C₂-C₆ alkenyl, optionally substituted by one or more C₁-C₃ alkyl. In some embodiments, each of R⁷ and R⁸ is independently a unsubstituted C₂-C₆ alkenyl. In some embodiments, each of R⁷ and R⁸ is independently a C₂-C₄ alkenyl, substituted by one or more methyl. Each of B₁ and B₂ is independently absent, —O—, —OC(O)—, —C(O)O—, —C(O)—, —N(H)—, —N(H)C(O)-, or —C(O)N(H)-. In some embodiments, each of B₁ and B₂ is independently absent, —OC(O)—, —C(O)O—, —N(H)C(O)-, or —C(O)N(H)-.

In some embodiments, the crosslinker has the structure of formula:

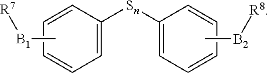

The integer n is 2 or 3. In one embodiment, n is 2. In one embodiment, n is 3. Each of R⁷ and R⁸ is independently a C₂-C₆ alkenyl, optionally substituted by one or more C₁-C₃ alkyl. In some embodiments, each of R⁷ and R⁸ is independently a unsubstituted C₂-C₆ alkenyl. In some embodiments, each of R⁷ and R⁸ is independently a C₂-C₄ alkenyl, substituted by one or more methyl. Each of B¹ and B² is independently absent, —O—, —OC(O)—, —C(O)O—, —C(O)—, —N(H)—, —N(H)C(O)-, or —C(O)N(H)-. In some embodiments, each of B¹ and B² is independently —OC(O)—, —C(O)O—, —N(H)C(O)-, or —C(O)N(H)-.

Exemplary crosslinkers are:

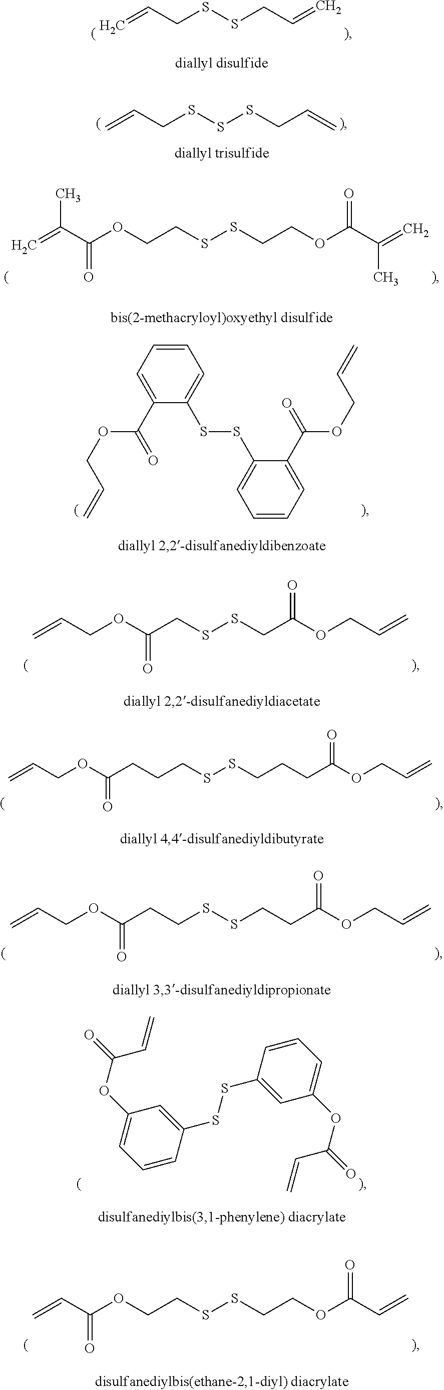

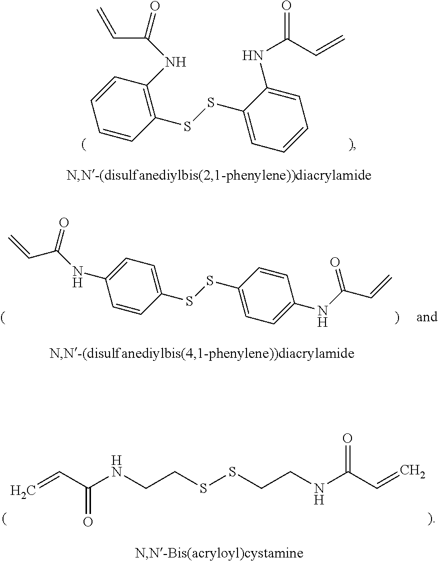

In some embodiments, the crosslinker comprises diallyl disulfide. In one embodiment, the crosslinker consists of diallyl disulfide.

The one or more monomers in the polymerizable composition for making a reversibly-crosslinked polymer can comprise an olefin monomer, a vinyl monomer, or a vinyl ester monomer.

Suitable olefin monomer can include a linear or branched olefin (e.g., an a-olefin) having 2 to 12 carbon atoms, 2 to 10 carbon atoms, or 2 to 8 carbon atoms. Exemplary linear or branched olefins includes, but are not limited to, ethylene, propylene, 1-butene, 2-butene, 1-pentene, 3-methyl-1-butene, 4-methyl-1-pentene, 3-methyl-1-pentene, 1-hexene, 3,5,5-trimethyl-1-hexene, 4,6-dimethyl-1-heptene, 1-octene, 1-nonene, 1-decene, 1-undecene, and 1-dodecene. These olefins may contain one or more heteroatoms such as an oxygen, nitrogen, or silicon.

Suitable vinyl monomers can include a substituted vinyl, e.g., R^{a}R^{b}C═CR^{c}R^{d}, wherein R^{a} and R^{b} may each independently be hydrogen, halogen, alkyl, aryl (e.g., phenyl), arylalkyl (e.g., benzyl), heteroaryl (e.g., pyridinyl), alkenyl, arylalkenyl, hydroxylcarbonyl, alkoxycarbonyl, alkylaminecarbonyl, alkylcarbonyloxy, arylcarbonyloxy, or nitrile. Exemplary vinyl monomers include, but are not limited to, styrene, vinyl pyridine, acrylate, methacrylate, acrylonitrile, vinyl ester, vinyl chloride, isoprene.

Suitable vinyl ester monomers include aliphatic vinyl esters having 3 to 20 carbon atoms (e.g., 4 to 10 carbon atoms, or 4 to 7 carbon atoms). Exemplary vinyl esters are vinyl acetate, vinyl formate, vinyl propionate, vinyl valerate, vinyl butyrate, vinyl isobutyrate, vinyl pivalate, vinyl caprate, vinyl laurate, vinyl stearate, and vinyl versatate. Aromatic vinyl esters such as vinyl benzonate can also be used as vinyl ester monomers. Common vinyl ester monomers are vinyl acetate, vinyl propionate, vinyl laurate, or vinyl versatate (e.g., the vinyl ester of versatic acid, vinyl neononanoate, or vinyl neodecanoate). Typically, vinyl acetate is used from the perspective of good commercial availability and impurity-treating efficiency at the production. The vinyl esters of neononanoic acid (vinyl neononanoate) and neodecanoic acid (vinyl neodecanoate) are commercial products obtained from the reaction of acetylene with neononanoic acids and neodecanoic acids, respectively, which are commercially available as Versatic acid 9 and Versatic acid 10.

The monomer may be used alone, or two or more different monomers may be used in combination, when being used in the polymerizable composition for making a reversibly-crosslinked polymer.

In some embodiments, the one or more monomers in the polymerizable composition for making a reversibly-crosslinked polymer comprise at least one member selected from the group consisting of ethylene, propylene, 1-butene, 1-pentene, 1-hexene, 1-heptene, 1-octene, and vinyl acetate.

In one embodiment, the monomer in the polymerizable composition for making a reversibly-crosslinked polymer is ethylene.

In one embodiment, ethylene and vinyl acetate are used as monomers in the polymerizable composition for making a reversibly-crosslinked polymer.

The polymerization initiator may comprise a peroxide (e.g., a bifunctional peroxide, a peracetate compound, etc.), an azo compound, a nitroxide, other —C—C- free radical initiators, and a mixture thereof.

Suitable peroxide compounds used as the polymerization initiator include, but are not limited to, a cyclic ketone peroxide, a bifunctional peroxide, a dialkyl peroxide, a monoperoxycarbonate, a poly (t-butyl) peroxycarbonates polyether, a di-peroxyketal, a perester (e.g., a peracetate), and mixtures thereof. In some embodiments, the peroxide compound is a cyclic ketone peroxide, a bifunctional peroxide, a dialkyl peroxide, or a mixture thereof.

Exemplary peroxide compounds used as the polymerization initiator are benzoyl peroxide; dicumyl peroxide; di-tert-butyl peroxide; tert-butyl cumyl peroxide; t-butyl-peroxy-2-ethyl-hexanoate; tert-butyl peroxypivalate; tertiary butyl peroxyneodecanoate; t-butyl-peroxy-benzoate; t-butyl-peroxy-2-ethyl hexanoate; tert-butyl 3,5,5-trimethylhexanoate peroxide; tert-butyl peroxybenzoate; 2-ethylhexyl carbonate tert-butyl peroxide; 2,5-dimethyl-2,5-di(tert-butylperoxide)hexane; 1,1-di(tert-butylperoxide)-3,3,5-trimethylcyclohexane; 2,5 dimethyl-2,5-di(tert-butylperoxide)hexyne-3; 3,3,5,7,7 pentamethyl-1,2,4-trioxepane; butyl 4,4-di(tert-butylperoxide) valerate; di(2,4-dichlorobenzoyl)peroxide; di(4-methylbenzoyl)peroxide; peroxide di(tert butylperoxyisopropyl)benzene; 2,5-di(cumylperoxy)-2,5-dimethyl hexane; 2,5-di(cumylperoxy)-2,5-dimethylhexyne; 3,4-methyl-4-(t-butylperoxy)-2-pentanol; 4-methyl-4-(t-amylperoxy)-2-pentanol; 4 methyl-4-(cumylperoxy)-2-pentanol; 4-methyl-4-(t-butylperoxy)-2-pentanone; 4-methyl-4-(t-amylperoxy)-2 pentanone; 4-methyl-4-(cumylperoxy)-2-pentanone; 2,5 dimethyl-2,5-di-t-butylperoxy) hexane; 2,5-dimethyl-2,5-di(t-amylperoxy)hexane; 2,5-dimethyl-2,5-di(t-butylperoxy)hexyne-3.2.5-dimethyl-2,5-di(t-amylperoxy)bexyne-3,2,5- dimethyl-2-t-butylperoxy-5-hydroperoxyhexane; 2,5-dimethyl-2-cumylperoxy-5-hydroperoxy hexane; 2,5-dimethyl-2-t-amylperoxy-5-hydroperoxyhexane; m/p-alpha, alpha-di[(t-butylperoxy)isopropyl]benzene; 1,3,5-tris (t-butylperoxyisopropyl)benzene; 1,3,5-tris(t-amylperoxyisopropyl)benzene; 1,3,5-tris(cumylperoxyisopropyl)benzene; di[1,3-dimethyl-3-(t-butylperoxy)butyl]carbonate; di[1,3-dimethyl-3-(t-amylperoxy)butyl]carbonate; di[1,3-dimethyl-3-(cumylperoxy)butyl]carbonate; di-t-amyl peroxide; t-amyl cumyl peroxide; t-butyl-isopropenylcumyl peroxide; 2,4,6-tri(butylperoxy)-s-triazine; 1,3,5-tri[1-(t-butylperoxy)-1-methylethyl]benzene; 1,3,5-tri-[(t-butylperoxy)-isopropyl]benzene; 1,3-dimethyl-3-(t-butylperoxy)butanol; 1,3-dimethyl-3-(t-amylperoxy)butanol; di(2-phenoxyethyl)peroxydicarbonate; di(4-t-butylcyclohexyl)peroxydicarbonate; dimyristyl peroxydicarbonate; dibenzyl peroxy decarbonate; di(isobomyl)peroxydicarbonate; 3-cumylperoxy-1,3-dimethylbutyl methacrylate: 3-t-butylperoxy-1,3-dimethylbutyl methacrylate; 3-t-amylperoxy-1,3-dimethylbutyl methacrylate; tri(1,3-dimethyl-3-t-butylperoxy butyloxy)vinyl silane; 1,3-dimethyl-3-(t-butylperoxy)butyl N-[1-{3-(1-methylethenyl)-phenyl)1-methylethyl]carbamate; 1,3-dimethyl-3-(t-amylperoxy)butyl N-[1-{3 (1-methylethenyl)-phenyl}-1-methylethyl]carbamate; 1,3-dimethyl-3-(cumylperoxy))butyl N-[1-{3-(1-methylethenyl)-phenyl}-1-methylethyl]carbamate; 1,1-di(t-butylperoxy)-3,3,5-trimethylcyclohexane; 1,1-di(t-butylperoxy)cyclohexane; n-butyl 4,4-di(t-amylperoxy)valerate; ethyl 3,3-di(t-butylperoxy)butyrate; 2,2-di(t-amylperoxy)propane; 3,6,6,9,9-pentamethyl-3-ethoxycabonylmethyl-1,2,4,5-tetraoxacyclononane; n-butyl-4,4-bis(t-butylperoxy)valerate; ethyl-3,3-di(t-amylperoxy)butyrate: benzoyl peroxide; OO-t-butyl-O-hydrogen-monoperoxy-succinate; OO-t-amyl-O-hydrogen-monoperoxy-succinate; 3,6,9, triethyl-3,6,9-trimethyl-1, 4, 7-triperoxynonane (or methyl ethyl ketone peroxide cyclic trimer); methyl ethyl ketone peroxide cyclic dimer; 3,3,6,6.9.9-hexamethyl-1,2,4,5-tetraoxacyclononane: 2,5-dimethyl-2,5-di(benzoylperoxy)hexane; t-butyl perbenzoate, t-butylperoxy acetate; t-butylperoxy-2-ethyl hexanoate; t-amyl perbenzoate: t-amyl peroxy acetate; t-butyl peroxy isobutyrate; 3-hydroxy-1,1-dimethyl-t-butyl peroxy-2-ethyl hexanoate; OO-t-amyl-O-hydrogen-monoperoxy succinate; OO-t-butyl-O-hydrogen-monoperoxy succinate; di-t-butyl diperoxyphthalate; t-butylperoxy (3,3,5-trimethylhexanoate); 1,4-bis(t-butylperoxycarbo)cyclohexane; t-butylperoxy-3,5,5-trimethylhexanoate; t-butyl-peroxy-(cis-3-carboxy)propionate; allyl 3-methyl-3-t-butylperoxy butyrate; OO-t-butyl-O-isopropylmonoperoxy carbonate; OO-t-butyl-O-(2-ethyl hexyl) monoperoxy carbonate; 1,1,1-tris [2-((-butylperoxy-carbonyloxy)ethoxymethyl]propane; 1,1,1-tris [2-(t-amylperoxy-carbonyloxy)ethoxymethyl]propane; 1, 1,-tris [2-(cumylperoxy-cabonyloxy)ethoxymethyl]propane; OO-t-amyl-O-isopropylmonoperoxy carbonate; di(4-methylbenzoyl)peroxide; di(3-methylbenzoyl)peroxide; di(2-methylbenzoyl)peroxide; didecanoyl peroxide; dilauroyl peroxide: 2,4-dibromo-benzoyl peroxide, succinic acid peroxide, dibenzoyl peroxide; di(2,4-dichloro-benzoyl)peroxide; and combinations thereof.

Suitable azo compounds used as the polymerization initiator include, but are not limited to azobisisobutyronitrile (AIBN); 2,2′-azobis( amidinopropyl)dihydrochloride; and azo-peroxide initiators that contain mixtures of a peroxide with one or more azodinitrile compounds including, e.g., 2,2′-azobis(2-methyl-pentanenitrile); 2,2′-azobis(2-methyl-butanenitrile); 2,2′-azobis(2-ethyl-pentanenitrile); 2-[(1-cyano-1-methylpropyl)azo]-2-methyl-pentanenitrile; 2-[(1-cyano-1-ethylpropyl)azo]-2-methyl-butanenitrile; and 2-[(1-cyano-1-methylpropyl)azo]-2-ethyl-pentanenitrile.

Suitable nitroxide compounds used as the polymerization initiator include, but are not limited to 2,2,5,5-tetramethy 1-1-pyrrolidinyloxy, 3-carboxy-2,2,5,5-tetramethyl-pyrrolidinyloxy, 2,2,6,6-tetramethyl-1-piperidinyloxy, 4-hydroxy-2,2,6,6-tetramethyl-1-piperidinyloxy, 4-methoxy-2,2,6,6-tetramethyl-1-piperidinyloxy, 4-oxo-2,2,6,6-tetramethyl-1-piperidinyloxy, bis-(1-oxy 1-2,2,6,6-tetramethylpiperidine-4-yl)sebacate, 2,2,.6,6-tetramethyl-4-hydroxypiperidine-1-oxyl)monophosphonate, N-tert-buty 1-1-diethylphosphono-2,2-dimethyl propyl nitroxide, N-tert-butyl-1-dibenzylphosphono-2,2-dimethylpropyl nitroxide, N-tert-butyl-1-di(2,2,2-trifluoroethyl)phosphono-2,2dimethylpropyl nitroxide, N-tert-butyl-(1-diethylphosphono)-2-methyl-propyl nitroxide, N-(1-methylethyl)-1-cyclohexyl-1-(diethylphosphone)nitroxide, N-(1-phenylbenzyl)-(1-diethylphosphono)-1-methyl ethylnitroxide, N-phenyl-1-diethylphosphono-2,2-dimethyl propyl nitroxide, N-phenyl-1-diethylphosphono-1-methyl ethyl nitroxide, N-(1-phenyl 2-methyl propyl)-1-diethylphosphono-1-methyl ethyl nitroxide, N-tert-butyl-1-phenyl-2-methyl propyl nitroxide, N-tert-butyl-1-(2-naphthyl)-2-methyl propyl nitroxide, and combinations thereof.

Accordingly, one embodiment of this application relates to a polymerizable composition having a polymerization initiator that comprises at least one member selected from the group consisting of azobisisobutyronitrile (AIBN); 2,2′-azobis(amidinopropyl)dihydrochloride; and azo-peroxide initiators that contain mixtures of a peroxide with one or more azodinitrile compounds selected from the group consisting of 2,2′-azobis(2-methyl-pentanenitrile); 2,2′-azobis(2-methyl-butanenitrile); 2,2′-azobis(2-ethyl-pentanenitrile); 2-[(1-cyano-1-methylpropyl)azo]-2-methyl-pentanenitrile; 2-[(1-cyano-1-ethylpropyl)azo]-2-methyl-butanenitrile; and 2-[(1-cyano-1-methylpropyl)azo]-2-ethyl-pentanenitrile. Another embodiment of this invention relates to a polymerizable composition having a polymerization initiator that comprises (a) at least one member selected from the group consisting of a peroxide, an azo compound, a peracetate compound, a nitroxide, azobisisobutyronitrile (AIBN); 2,2′-azobis(amidinopropyl)dihydrochloride; or (b) an azo-peroxide initiator that comprises a mixture of a peroxide with one or more azodinitrile compounds selected from the group consisting of 2,2′-azobis(2-methyl-pentanenitrile); 2,2′-azobis(2-methyl-butanenitrile); 2,2′-azobis(2-ethyl-pentanenitrile); 2-[(1-cyano-1-methylpropyl)azo]-2-methyl-pentanenitrile; 2-[(1-cyano-1-ethylpropyl)azo]-2-methyl-butanenitrile; and 2-[(1-cyano-1-methylpropyl)azo]-2-ethyl-pentanenitrile.

In some embodiments, the polymerization initiator comprises at least one member selected from the group consisting of 2,3-dimethyl-2,3-diphenylbutane; 3,4-dimethyl-3,4-diphenylhexane; 3,4-diethyl-3,4-diphenylhexane; 3,4-dibenzyl-3,4-ditolylhexane; 2,7-dimethyl-4,5-diethyl-4,5-diphenyloctane; and 3,4-dibenzyl-3,4-diphenylhexane.

### Polymerization and Crosslinking Reaction

Another aspect of the invention relates to a method of making a reversibly-crosslinked polymer, comprising: reacting a crosslinker comprising a —Sₙ- moiety and having at least two polymerizable groups, wherein n is an integer of from 2 to 8, and one or more monomers, each monomer having at least one C═C double bond capable of undergoing a polymerization reaction, in the presence of the polymerization initiator, to produce a reversibly-crosslinked polymer that, when reprocessed at temperatures greater than 50° C., dissociate the crosslinking bonds of the reversibly-crosslinked polymer.

All above descriptions and all embodiments regarding the polymerizable composition for making the reversibly-crosslinked polymer, including the crosslinkers, one or more monomers, and polymerization initiators, discussed above in the aspect of the invention relating to the polymerizable composition are applicable to this aspect of the invention. During the reacting step, the one or more monomers form a polymer network via the at least one C═C double bond that allows the monomers to undergo a polymerization reaction. The dynamic crosslinker has at least two polymerizable groups (e.g., a C═C double bond) that allow for the incorporation of the crosslinker into the polymer network during polymerization reaction. Because of the polymerizable groups contained in the dynamic crosslinker, the dynamic crosslinker can serve as another monomer during the polymerization, forming a copolymer or terpolymer with the monomer or monomers. For instance, polymerization of an ethylene monomer using a diallyl disulfide as the crosslinker can generate an ethylene/diallyl disulfide copolymer; polymerization of ethylene monomer and vinyl acetate monomer using a diallyl disulfide as the crosslinker can generate an ethylene/vinyl acetate/diallyl disulfide terpolymer. The dynamic crosslinker also serve to link the polymer chains formed by the one or more monomers, forming an extensive crosslinking network.

The polymerization reaction can be carried out by various polymerization mechanisms known to one skilled in the art. For instance, free-radical polymerization is common polymerization mechanism and is suitable for the reaction herein. Free-radical polymerization is a type of chain-growth (chain-addition) polymerization that starts by initiating free radicals which add monomer units, thereby growing the polymer chain. Any type of initiation to generate free radicals (free radical initiation) can be suitable herein for the polymerization reactions. For instance, free radicals can be initiated by thermal initiation, radiation initiation (such as photo initiation), irradiation initiation (such as ionizing radiations, e.g., gamma and X-rays), or combinations thereof.

The reaction is typically carried out under a pressure above atmospheric pressure. For instance, the pressure for the polymerization and/or crosslinking reaction is at least 5 bar, and typically ranges from 5 bar to 5,000 bar, from 5 bar to 500 bar, from 5 bar to 200 bar, from 1000 bar to 5000 bar, from 1500 bar to 5000 bar, from 1000 bar to 3000 bar, from 1500 bar to 3000 bar, from 1000 bar to 2000 bar, or from 1000 bar to 3000 bar.

The reaction is typically carried out at an elevated temperature under a wide temperature range. The reaction temperature for the polymerization and/or crosslinking reaction is typically at least 30° C., and can range from 30° C. to 350° C., for instance, from 150° C. to 350° C., from 150° C. to 280° C., from 150° C. to 230° C., from 150° C. to 180° C., from 30° C. to 280° C., from 30° C. to 230° C., from 30° C. to 180° C., or from 30° C. to 130° C. Suitable reaction temperatures should take into consideration the polymerization initiator used and the dynamic crosslinker used. For instance, suitable reaction temperatures should be at least higher than the decomposition temperature of the polymerization initiator. Suitable reaction temperatures should also be no higher than the dissociation temperature of the crosslinker so that the crosslinking bonds (i.e., the disulfide or polysulfide linkages) in the crosslinker do not dissociate during the reaction.

The reaction conditions may also involve the use of an inert gas (e.g., N₂ gas).

The reaction may be carried out in the presence or absence of a solvent. The solvent may be used to dissolve the monomer or dynamic crosslinker. Suitable solvents include, but are not limited to, deep eutectic solvents; eutectic mixtures; ionic liquids; dimethyl carbonate (green solvent); ethers such as petroleum ether, tetrahydrofuran, or 1,4-dioxane; hydrocarbon solvents such as cyclohexane, heptane, or toluene; esters such as ethyl acetate; ketones (such as acetone or butanone or clyclohexanone); chlorinated solvents, such as dichloromethane; alcohols such as methanol, ethanol, butan-2-ol, butan-1-ol, isopropanol, ethylene glycol, or glycerol; and combinations thereof. In some embodiments, the solvent is water, DMSO, dimethylformamide, butyrolactone, or 1,4-dioxane. In some embodiments, the solvent is an anhydrous liquid. In one embodiment, the solvent is dimethyl carbonate.

The polymerization and/or crosslinking reaction may be carried out in a batch process as a bulk reaction or in a continuous process as a continuous reaction, under the reaction temperature and pressure as discussed above.

To initiate the polymerization and/or crosslinking reaction, the amount of the polymerization initiator present in the polymerizable composition typically ranges from 1×10⁻⁷ wt % to 5.0 wt %, for instance, from 0.001 wt % to 5.0 wt %, from 0.05 wt % to 5.0 wt %, from 0.01 wt % to 5.0 wt %, from 0.05 wt % to 5.0 wt %, from 0.01 wt % to 4.0 wt %, from 0.05 wt % to 4.0 wt %, from 0.01 wt % to 3.0 wt %, from 0.05 wt % to 3.0 wt %, from 0.01 wt % to 2.0 wt %, from 0.05 wt % to 2.0 wt %, from 0.01 wt % to 1.0 wt %, from 0.05 wt % to 1.0 wt %, from 0.1 wt % to 1.0 wt %, or from 0.1 wt % to 0.5 wt %, relative to 100 wt % of the total amount of the polymerizable composition (comprising the crosslinker, monomers, and polymerization initiator).

Suitable monomers for the polymerization and/or crosslinking reaction are those described herein above. In some embodiments, the one or more monomers for the polymerization and/or crosslinking reaction comprise at least one member selected from the group consisting of ethylene, propylene, 1-butylene, 1-pentene, 1-hexene, 1-heptene, 1-octene, and vinyl acetate.

In one embodiment, the monomer for the polymerization and/or crosslinking reaction is ethylene. The ethylene polymer by polymerization may form high-density polyethylene (HDPE), linear low-density polyethylene (LLDPE), low-density polyethylene (LDPE), or medium-density polyethylene (MDPE).

In one embodiment, ethylene and vinyl acetate are used as monomers for the polymerization and/or crosslinking reaction. The copolymer of ethylene and vinyl acetate by polymerization may form ethylene-vinyl acetate copolymer (EVA), also known as poly (ethylene-vinyl acetate) (PEVA), the type of which depends upon different vinyl acetate (VA) content: e.g., low-VA (approximately up to 4%) EVA, which has properties similar to a LDPE but has increased gloss, softness, and flexibility; medium-VA (approximately 4-30%) EVA, having properties of a thermoplastic elastomer material; and high-VA (greater than 33%) EVA, having properties similar to a rubber.

Suitable dynamic crosslinkers for the polymerization and/or crosslinking reaction are those described herein above. In some embodiments, the crosslinker comprises at least one member selected from the group consisting of diallyl disulfide, diallyl trisulfide, bis(2-methacryloyl)oxyethyl disulfide (DSDMA), ((((disulfanediylbis(4,1-phenylene))bis(azanediyl))bis(carbonyl))bis(azanediyl))bis(ethane-2,1-diyl)bis(2-methylacrylate) (4MUPD), diallyl 2,2′-disulfanediyldibenzoate, diallyl 2,2′-disulfanediyldiacetate, diallyl 4,4′-disulfanediyldibutyrate, diallyl 3,3′-disulfanediyldipropionate, Disulfanediylbis(3,1-phenylene) diacrylate, disulfanediylbis(ethane-2,1-diyl) diacrylate, N,N′-(disulfancdiylbis(2,1-phenylene))diacrylamide, N,N′-(disulfanediylbis(4,1-phenylene))diacrylamide, and N,N′-Bis(acryloyl)cystamine. In one embodiment, the crosslinker comprises diallyl disulfide.

The dynamic crosslinker may be present in the polymerizable composition at various amounts, for instance, in an amount ranging from 0.01 wt % to 50 wt %, from 0.05 wt % to 50 wt %, from 0.1 wt % to 50 wt %, from 0.5 wt % to 50 wt %, from 1 wt % to 50 wt %, from 5 wt % to 50 wt %, from 0.1 wt % to 40 wt %, from 0.5 wt % to 40 wt %, from 1 wt % to 40 wt %, from 5 wt % to 40 wt %, from 0.1 wt % to 30 wt %, from 0.5 wt % to 30 wt %, from 0.1 wt % to 20 wt %, from 0.5 wt % to 20 wt %, from 1 wt % to 20 wt %, from 5 wt % to 20 wt %, from 0.1 wt % to 10 wt %, from 0.5 wt % to 10 wt %, from 1 wt % to 10 wt %, or from 5 wt % to 10 wt %, relative to 100 wt % of the total amount of the polymerizable composition (comprising the crosslinker, monomers, and polymerization initiator). In terms of mol %, the dynamic crosslinker may be present in the polymerizable composition in an amount of at least 0.01 mol %, at least 0.05 mol %, at least 0.1 mol %, at least 0.5 mol %, at least 1 mol %, at least 2 mol %, at least 3 mol %, at least 4 mol %, at least 5 mol %, or in a range of from 0.01 mol % to 35 mol % (e.g., from 0.05 mol % to 35 mol %, from 0.1 mol % to 35 mol %, from 0.5 mol % to 35 mol %, from 1 mol % to 35 mol %, from 5 mol % to 35 mol %, from 1 mol % to 30 mol %, from 5 mol % to 30 mol %, from 1 mol % to 25 mol %, from 5 mol % to 25 mol %, from 1 mol % to 20 mol %, from 5 mol % to 20 mol %, from 1 mol % to 15 mol %, from 5 mol % to 15 mol %, from 1 mol % to 10 mol %, or from 5 mol % to 10 mol %), relative to 100 mol % of the total amount of the polymerizable composition (comprising the crosslinker, monomers, and polymerization initiator).

The reversibly-crosslinkable polymer and its reprocessing

The method discussed above results in a reversibly-crosslinkable polymer. Thus, another aspect of the invention relates to reversibly-crosslinkable polymer obtained according to the method as described from the above aspect of the invention.

All above descriptions and all embodiments regarding the polymerizable composition for making the reversibly-crosslinked polymer, including the crosslinkers, one or more monomers, and polymerization initiators, discussed above in the aspect of the invention relating to the polymerizable composition are applicable to this aspect of the invention.

All above descriptions and all embodiments regarding the method of making a reversibly-crosslinked polymer, including various suitable reagents, reaction mechanisms, and reaction conditions discussed above in the aspect of the invention relating to the method of making a reversibly-crosslinked polymer, are applicable to this aspect of the invention.

As discussed above, the method generates a reversibly-crosslinkable polymer, comprising the reaction product of the polymerizable composition as discussed herein above. In the resulting reversibly-crosslinkable polymer, the dynamic crosslinker may be incorporated into the reversibly-crosslinkable polymer in an amount of from about 0.01 wt % to about 50 wt %, for instance, in an amount ranging from 0.05 wt % to 50 wt %, from 0.1 wt % to 50 wt %, from 0.5 wt % to 50 wt %, from 1 wt % to 50 wt %, from 5 wt % to 50 wt %, from 0.1 wt % to 40 wt %, from 0.5 wt % to 40 wt %, from 1 wt % to 40 wt %, from 5 wt % to 40 wt %, from 0.1 wt % to 30 wt %, from 0.5 wt % to 30 wt %, from 0.1 wt % to 20 wt %, from 0.5 wt % to 20 wt %, from 1 wt % to 20 wt %, from 5 wt % to 20 wt %, from 0.1 wt % to 10 wt %, from 0.5 wt % to 10 wt %, from 1 wt % to 10 wt %, or from 5 wt % to 10 wt %, relative to 100 wt % of the total amount of the reversibly-crosslinkable polymer.

The resulting polymer network in the reversibly-crosslinkable polymer contains a —S—S- bond that is dynamic and can undergo dissociation and reassociation at different conditions (e.g., upon changing the temperature), allowing for the polymer to be re-processed and recycled when the polymer is subjected to a stimulus.

The resulting reversibly-crosslinkable polymer may be reprocessed by heating from a temperature at which dissociation of the reversible crosslinking bonds (e.g., —S—S- bonds) is inactive or substantially inactive (e.g., at room temperature) to an elevated temperature at which the dissociation of the reversible crosslinking bonds (e.g., —S—S- bonds) is activated or significantly enhanced (e.g., at temperatures greater than 50° C., greater than 60° C., greater than 70° C., greater than 80° C., greater than 90° C., greater than 100° C., greater than 110° C., greater than 120° C., greater than 130°° C., greater than 140° C., or greater than 150° C., depending on the individual crosslinker used). Thus, suitable reprocessing/recycling temperatures can be at least 50° C., at least 60° C., at least 70° C., at least 80° C., at least 90° C., at least 100° C., at least 110° C., at least 120° C., at least 130° C., at least 140°° C., or at least 150° C., depending on the individual crosslinker used. In some embodiments, the reprocessing/recycling temperatures are in a range of 120° C. to 160° C. The polymers may be reshaped (e.g., remolded) at the reprocessing/recycling temperatures. Then the reprocessed/recycled polymers can be cooled down, e.g., back to room temperature. During cooling, the reversible linkage (e.g., —S—S- bond) reassociates, thereby reforming the polymer network. A single reprocessing/recycling cycle may be a single round of heating, reshaping, and cooling. The heating used to reprocess/recycle the reversibly-crosslinkable polymers can be relatively short (e.g., 5 hours, 4 hours, 3 hours, 2 hours, 1 hour, 30 minutes, or less) and still provide the reprocessed polymer network with full recovery of crosslinking density (as compared to the initial polymer network prior to any reprocessing/recycling).

The reversibly-crosslinkable polymer after a reprocessing/recycling cycle maintains the polymer properties (as compared to those of the original polymer prior to any reprocessing/recycling). Thus, the polymerizable composition and method described herein allow for preparation of a fully reprossessble/recyclable polymer (as compared to conventional polymers prepared without using the dynamic crosslinkers described herein).

### EXAMPLES

The following examples are for illustrative purposes only and are not intended to limit, in any way, the scope of the present invention.

### Example 1

### Synthesis of an Exemplary Reversibly Crosslinked Polymer

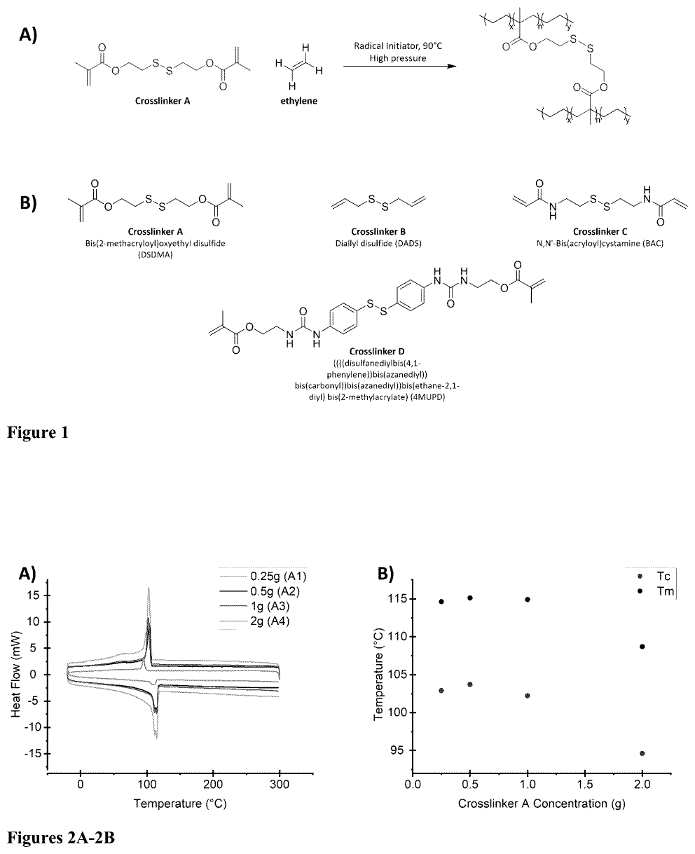

In this example, an exemplary reversibly crosslinked polymer was synthesized using ethylene as a monomer and different dynamic disulfide as dynamic crosslinkers. Dynamic crosslinkers A-D, as shown in FIG. 1, were used to produce the examples.

The polymers were produced in a reactor via free radical polymerization. Due the nature of the polymers produced being crosslinker, differential scanning calorimetry (DSC) was performed on resulting polymer samples to determine comonomer (dynamic crosslinker) incorporation in the polymer network. It is known for ethylene-based polymers that increasing comonomer (and/or dynamic crosslinker) content result in a decrease in crystallization temperature (Tc) and melting temperature (Tm).

DSC was performed under nitrogen in a TA Q2000 instrument. A sample was heated to 300°° C. at 10° C./min, held at this temperature for 1 minute, cooled down to −20°° C. at 10° C./min and held at this temperature for 1 minute. Then the sample was heated up to 300° C. at 10° C./min. Table 1 shows the temperature of crystallization (Tc), melting temperature (Tm, second melting cycle), and endothermic ΔH (J/g, second melting cycle).

For the swelling studies, ˜0.1 g of polymer sample was put in 10 mL of toluene or 10 mL xylenes and heated to ˜100° C. for 2 hours. Table 2 shows the recorded observations from the swelling studies of the polymer samples.

TABLE 1
DSC results

| | | | | |
|---|---|---|---|---|
| | Monomer | T_{c} peak | Tₘ peak | Endothermic |
| Samples | Concentration | (° C.) | (° C.) | ΔH (J/g) |

| | | | | | |
|---|---|---|---|---|---|
| A1 | 0.265 | g | 102.9 | 114.6 | 106.7 |
| A2 | 0.509 | g | 103.7 | 115.1 | 106.4 |
| A3 | 1.002 | g | 102.2 | 114.9 | 105.7 |
| A4 | 2.007 | g | 94.6 | 108.7 | 31.8 |
| A5 | 0.499 | g | — | — | — |
| B1 | 0.5 | ml | 97.5 | 104.3 | 69.0 |
| B2 | 1.0 | ml | 87.0 | 96.24 | 23.2 |
| C1 | 0.258 | g | 98.8 | 110.5 | 14.6 |
| C2 | 0.997 | g | 94.9 | 109.08 | 16.5 |
| C3 | 2.075 | g | 88.7 | 101.89 | 63.5 |
| D1 | 0.258 | g | 96.4 | 107.2 | 120.37 |
| D2 | 0.504 | g | 94.8 | 104.2 | 124.9 |
| D3 | 1.005 | g | 94.9 | 106.35 | 72.2 |
| D4 | 0.260 | g | 99.3 | 110.0 | 47.5 |
| D5 | 0.517 | g | 98.2 | 107.3 | 37.9 |

TABLE 2
Swelling Study

| | Monomer | Xylenes | Toluene |
|---|---|---|---|
| Samples | Concentration | (~100° C.) | (~100° C.) |
| A1 | 0.265 g | yes | yes |
| A2 | 0.509 g | partially | partially |
| A3 | 1.002 g | no | yes |
| A4 | 2.007 g | no | no |
| A5 | 0.499 g | — | — |
| B1 | 0.504 g | yes | yes |
| B2 | 1.016 g | yes | yes |
| C1 | 0.258 g | partially | partially |
| C2 | 0.997 g | no | no |
| C3 | 2.075 g | — | — |
| D1 | 0.258 g | — | — |
| D2 | 0.504 g | — | — |
| D3 | 1.005 g | — | — |
| D4 | 0.260 g | — | — |
| D5 | 0.517 g | — | — |

### Example 1a

### Synthesis of an Exemplary Reversibly Crosslinked Polymer (Crosslinker A)

In this example, ethylene-based polymers incorporating dynamic crosslinker A, bis(2-methacryloyl)oxyethyl disulfide (DSDMA), were produced at various concentrations of dynamic crosslinker via free radical polymerization. Ethylene (99.95%, Air Liquide, 1200 psi), bis(2-methacryloyl)oxyethyl disulfide (Sigma Aldrich), 2,2′-azobisisobutyronitrile (AIBN, 98%, Sigma Aldrich) and dimethyl carbonate (DMC, anhydrous 99%, Sigma Aldrich) were used as received. In a Parr reactor, 100 mL DMC, 0.1 g AIBN, and DSDMA (0.25, 0.5, 1.0, or 2.0 g) were added.

The reactor was sealed and purged three times with nitrogen while stirring. After the final nitrogen purge, the system was filled with 50 L of ethylene and heated to 90° C. for 4 hours. Reactors reached a final pressure ranging from 90-105 bar. The reaction mixture was collected and washed with additional DMC. The polymer was dried overnight in a vacuum oven (samples A1-A5, Tables 1-2).

FIG. 2A depicts the DSC chromatographs of crosslinker A-ethylene polymers, with varying concentrations of crosslinker A (concentrations A1-A5, as shown in Tables 1 and 2). The expected trend is observed, whereas comonomer concentration is increased, both the Tm and Te decrease, as depicted by FIG. 2B. FIG. 3A depicts the storage modulus and tan delta of the 1 g DSMDA-ethylene copolymer (sample A3). Dynamic mechanical analysis (DMA) measurements were performed on a TA 800 DMA instrument in tensile mode. Thin film samples were prepared using a carver press at 175° C. and 10 tons for 1 hour. The sample is cooled to −100° C. and a temperature sweep was performed to 80°° C. at 3° C./min to determined viscoelastic response. A preload force of 0.01 N with a frequency of 1 Hz were applied, and a set amplitude is predetermined via strain sweep.

For the swelling studies, ˜0.1 g of polymer was put in 10 mL of toluene or 10 mL xylenes. Both samples were heated to ˜100° C. for 2 hours. The samples did not dissolve after 2 hours, indicating a crosslinked polymer network, as shown in FIG. 3B. DSDMA contains a dynamic disulfide bond, therefore a polymer containing DSDMA will be a dynamic polymer. To examine the dynamic nature of the polymer, stress relaxation tests (G (t)/G (0)) were performed. Stress relaxation experiments were performed on an ARES G2 Rheometer using a parallel plate geometry with a diameter of 25.0 mm and a gap of 1.0 mm. Samples were prepared using a Carver press at 175° C. for 1 hour and 10 tons of pressure. Each sample undergoes a strain sweep from 0.1-100% to determine a strain that is within the material's linear viscoelastic region and each sample is conditioned at test temperature for 30 minutes prior to testing. Tests were performed at 1% constant strain for 10,000 s at selected temperature.

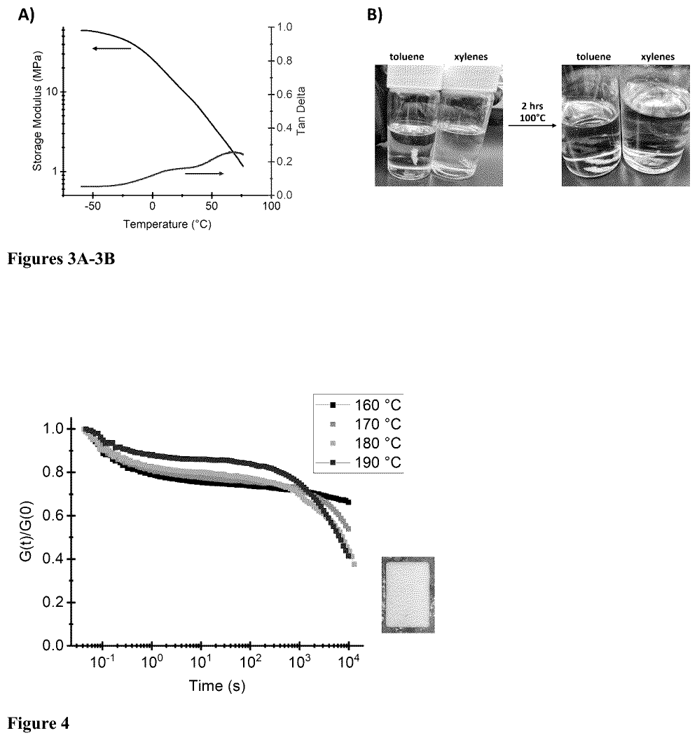

FIG. 4 shows the normalized stress relaxation of sample A3 at 160, 170, 180, and 190° C. The sample performed at 160° C. did not exhibit any stress relaxation, but the samples performed at 170, 180, and 190° C. all exhibited fast stress relaxation at higher timescales.

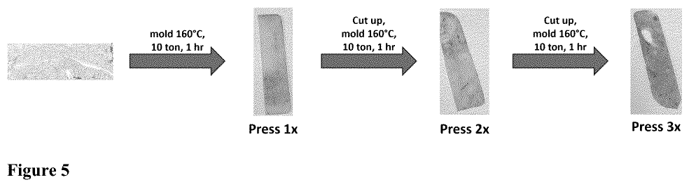

In addition to stress relaxation indicating the dynamic nature of these polymers, reprocessability studies were performed. FIG. 5 depicts the reprocessability study for sample A5. A polymer sample obtained from the reactor was molded in a Carver press at 160° C. for 1 hour with 8-10 tons of pressure and then put in a cold press (room temperature) for 5 minutes with 8-10 tons of pressure. The molded sample was homogenous, with no visible weld lines (press 1x). The press 1x molded sample was then cut up into 3-5 mm pieces and repressed with the same conditions (160° C. for 1 hour with 8-10 tons of pressure). The molded sample (press 2x) was homogenous. The same process was performed to obtain a press 3x molded sample, which was also homogenous. The reprocessability indicates the dynamic nature of the polymer network.

### Example 1b

### Synthesis of an Exemplary Reversibly Crosslinked Polymer (Crosslinker B)

In this example, ethylene-based polymers incorporating dynamic crosslinker B, diallyl disulfide (DADS), were produced at various concentrations of dynamic crosslinker via free radical polymerization. Ethylene (99.95%, Air Liquide, 1200 psi), diallyl disulfide (>80% FG, Sigma Aldrich), 2,2′-azobisisobutyronitrile (AIBN, 98%, Sigma Aldrich) and dimethyl carbonate (DMC, anhydrous 99%, Sigma Aldrich) were used as received. In a Parr reactor, 100 mL DMC, 0.1 g AIBN, and DADS (0.5 or 1 mL) were added. The reactor was sealed and purged three times with nitrogen while stirring. After the final nitrogen purge, the system was filled with 50 L of ethylene and heated to 90° C. for 4 hours. Reactors reached a final pressure ranging from 100-105 bar. The reaction mixture was collected and washed with additional DMC. The polymer was dried overnight in a vacuum oven (samples B1 and B2; Tables 1-2).

### Example 1c

### Synthesis of an Exemplary Reversibly Crosslinked Polymer (Crosslinker C)

In this example, ethylene-based polymers incorporating dynamic crosslinker C, N,N′-Bis(acryloyl)cystamine (BAC), were produced at various concentrations of dynamic crosslinker via free radical polymerization. Ethylene (99.95%, Air Liquide, 1200 psi), N,N′-Bis(acryloyl)cystamine (Sigma Aldrich), 2,2′-azobisisobutyronitrile (AIBN, 98%, Sigma Aldrich) and acetone (99.5% ACS reagent, Sigma Aldrich were used as received. In a Parr reactor, 100 mL acetone, 0.1 g AIBN, and BAC (0.25, 1, or 2 g) were added. The reactor was sealed and purged three times with nitrogen while stirring. After the final nitrogen purge, the system was filled with 50 L of ethylene and heated to 90° C. for 4 hours. Reactors reached a final pressure ranging from 90-105 bar. The reaction mixture was collected and washed with additional acetone. The polymer was dried overnight in a vacuum oven (samples C1-C3; Tables 1-2).

### Example 1d

### Synthesis of an Exemplary Reversibly Crosslinked Polymer (Crosslinker D)

In this example, ethylene-based polymers incorporating a dynamic crosslinker D, ((((disulfanediylbis(4,1-phenylene)) bis(azanediyl)) bis(carbonyl)) bis(azanediyl)) bis(ethane-2,1-diyl) bis(2-methylacrylate) (4MUPD), were produced at various concentrations of dynamic crosslinker via free radical polymerization. Ethylene (99.95%, Air Liquide, 1200 psi), 2,2′-azobisisobutyronitrile (AIBN, 98%, Sigma Aldrich), acetone (99.5% ACS reagent, Sigma Aldrich), and tetrahydrofuran (THF, anhydrous 99%, Sigma Aldrich) were used as received. 4MUPD was synthesized using a predetermined method.2 In a Parr reactor, 100 mL THF or acetone, 0.1 g AIBN, and 4MUPD (0.25, 0.5, or 1 g) were added. The reactor was sealed and purged three times with nitrogen while stirring. After the final nitrogen purge, the system was filled with 50 L of ethylene and heated to 90° C. for 4 hours. Reactors reached a final pressure ranging from 90-95 bar. The reaction mixture was collected and washed with additional THF or acetone. The polymer was dried overnight in a vacuum oven. Polymers D1-D3 were polymerized in acetone and polymers D4 and D5 were polymerized in THF (Tables 1-2).

1. A polymerizable composition, comprising:
a crosslinker comprising a —Sₙ- moiety and having at least two polymerizable groups, wherein n is an integer of from 1 to 8,
one or more monomers, each monomer having at least one C═C double bond capable of undergoing a polymerization reaction, and
a polymerization initiator.

2. The polymerizable composition according to claim 1, wherein the crosslinker is represented by Formula (I), (II), (III), (IV) or (V):
R¹R²R³C—Sₙ—CR⁴R⁵R⁶ (I)
R⁷—CH (X)—Sₙ—CH(Y)—R⁸ (II)
R⁷—B₁—A₁—Sₙ—A₂—B₂—R⁸ (III)
R¹⁵—O—Sₙ—O—R¹⁶ (IV)
(R¹⁷)(R¹⁸)—P—Sₙ—P—(R¹⁹)(R²⁰) (V)
wherein:
n is an integer of from 2 to 8,
X represents CHR⁹R¹⁰, OH, SH, or NHR¹¹;
Y represents CHR¹²R¹³, OH, SH, or NHR¹⁴,
each of R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹ and R²⁰ is independently selected from the group consisting of a hydrogen atom, a halogen atom, a C₁₋₂₀ linear or branched alkyl, a C₂₋₂₀ alkenyl, a C₂₋₂₀ alkynyl, a nitrile, a hydroxyl, an ester having from 1 to 20 carbon atoms, an ether having from 1 to 20 carbon atoms, a thioether having from 1 to 20 carbon atoms, a ketone having from 1 to 20 carbon atoms, an imine, an amide, a primary amine, a secondary amine, a tertiary amine, a trifluoromethyl, a phenyl, a benzyl, a phenol, a pentafluorophenyl, a nitroxyl, and a silcone having from 1 to 20 carbon atoms; each optionally substituted by one or more alkyl, alkenyl, hydroxyl, or halogen atoms;
each of A₁ and A₂ is independently absent, a C₁-C₂₀ alkylene, a C₂-C₂₀ cycloalkylene, a divalent form of C₂-C₂₀ alkene, a divalent form of C₂-C₂₀ alkyne, an arylene, or combinations thereof, each optionally substituted by one or more alkyl, alkenyl, hydroxyl, or halogen atoms;
each of B₁ and B₂ is independently absent or a divalent form of imine, amine, amide, ether, or ester, or combinations thereof;
provided the following:
in Formula (I), at least one of R¹, R², and R³ comprises a C═C double bond and at least one of R⁴, R⁵, and R⁶ comprise a C═C double bond, and
in Formula (II) and (III), each of R⁷ and R⁸ comprises a C═C double bond.

3. (canceled)

4. The polymerizable composition according to claim 1, wherein the C═C double bond capable of undergoing a polymerization reaction is in a functional group comprising at least one member selected from the group consisting of an alkene, an alkyne, a nitrile, vinyl group, an acyl, an acrylate, a (meth) acrylate, a styrene, and a vinyl pyridine.

5. The polymerizable composition according to claim 2, wherein the crosslinker is represented by Formula (III), and wherein:
n is 2 or 3;
each of R⁷ and R⁸ is a C₂₋₂₀ alkenyl, optionally substituted by one or more alkyl or alkenyl;
each of A₁ and A₂ is independently absent, a C₁-C₂₀ alkylene or a divalent form of phenyl; each optionally substituted by one or more alkyl, alkenyl, hydroxyl, or halogen atoms; and
each of B₁ and B₂ is independently absent or a divalent form of amine, amide, ether, or ester.

6. The polymerizable composition according to claim 1, wherein the crosslinker comprises at least one member selected from the group consisting of diallyl disulfide, diallyl trisulfide, bis(2-methacryloyl) oxyethyl disulfide, diallyl 2,2′-disulfanediyldibenzoate, diallyl 2,2′-disulfanediyldiacetate, diallyl 4,4′-disulfanediyldibutyrate, diallyl 3,3′-disulfanediyldipropionate, disulfanediylbis(3,1-phenylene) diacrylate, disulfanediylbis(ethane-2,1-diyl) diacrylate, N,N′-(disulfanediylbis(2,1-phenylene))diacrylamide, N,N′-(disulfanediylbis(4,1-phenylene))diacrylamide, and N,N′-Bis(acryloyl)cystamine.

7. The polymerizable composition according to claim 1, wherein the crosslinker comprises at least one of diallyl disulfide, bis(2-methacryloyl)oxyethyl disulfide (DSDMA) and ((((disulfanediylbis(4,1-phenylene)) bis(azanediyl)) bis(carbonyl)) bis(azanediyl)) bis(ethane-2,1-diyl) bis(2-methylacrylate) (4MUPD).

8. (canceled)

9. The polymerizable composition according to claim 1, wherein the one or more monomers comprise at least one monomer selected from the group consisting of ethylene, propylene, 1-butylene, 1-pentene, 1-hexene, 1-heptene, 1-octene, and vinyl acetate.

10-12. (canceled)

13. The polymerizable composition according to claim 1, wherein the polymerization initiator comprises at least one member selected from the group consisting of a peroxide, an azo compound, a peracetate compound, a nitroxide, azobisisobutyronitrile (AIBN); 2,2′-azobis(amidinopropyl) dihydrochloride; or
the polymerization initiator comprises an azo-peroxide initiator that comprises a mixture of a peroxide with one or more azodinitrile compounds selected from the group consisting of 2,2′-azobis(2-methyl-pentanenitrile); 2,2′-azobis(2-methyl-butanenitrile); 2,2′-azobis(2-ethyl-pentanenitrile); 2-[(1-cyano-1-methylpropyl)azo]-2-methyl-pentanenitrile; 2-[(1-cyano-1-ethylpropyl)azo]-2-methyl-butanenitrile; and 2-[(1-cyano-1-methylpropyl)azo]-2-ethyl-pentanenitrile.

14. The polymerizable composition according to claim 1, wherein the polymerization initiator comprises at least one member selected from the group consisting of 2,3-dimethyl-2,3-diphenylbutane; 3,4-dimethyl-3,4-diphenylhexane; 3,4-diethyl-3,4-diphenylhexane; 3,4-dibenzyl-3,4-ditolylhexane; 2,7-dimethyl-4,5-diethyl-4,5-diphenyloctane; and 3,4-dibenzyl-3,4-diphenylhexane.

15. A method of making a reversibly-crosslinked polymer, comprising:
reacting a crosslinker comprising a —Sₙ- moiety and having at least two polymerizable groups, wherein n is an integer of from 1 to 8, and one or more monomers, each monomer having at least one C═C double bond capable of undergoing a polymerization reaction, in the presence of the polymerization initiator, to produce a reversibly-crosslinked polymer that, when reprocessed at temperatures greater than 50° C., dissociate the crosslinking bonds of the reversibly-crosslinked polymer.

16. The method according to claim 15, wherein said reacting is carried out by free-radical initiation, thermal initiation, radiation or irradiation initiation, or combinations thereof.

17. The method according to claim 15, wherein said reacting is carried out under a pressure of at least 5 bar.

18-19. (canceled)

20. The method according to claim 15, wherein said polymerization initiator is present in an amount of from 1×10⁻⁷ to 5 wt %, relative to 100 wt % of the total amount of the crosslinker, monomers, and polymerization initiator.

21. The method according to claim 15, wherein said reacting is carried out as a bulk reaction or a continuous reaction, under a pressure of at least 20 bar.

22. The method according to claim 15, wherein said reacting is carried out at a temperature of at least 30° C.

23-24. (canceled)

25. The method according to claim 15, wherein the crosslinker comprises at least one member selected from the group consisting of diallyl disulfide, diallyl trisulfide, bis(2-methacryloyl)oxyethyl disulfide, diallyl 2,2′-disulfanediyldibenzoate, diallyl 2,2′-disulfanediyldiacetate, diallyl 4,4′-disulfanediyldibutyrate, diallyl 3,3′-disulfanediyldipropionate, disulfanediylbis(3,1-phenylene) diacrylate, disulfanediylbis(ethane-2,1-diyl)diacrylate, N,N′-(disulfanediylbis(2,1-phenylene))diacrylamide, N,N′-(disulfanediylbis(4,1-phenylene))diacrylamide, and N,N′-Bis(acryloyl)cystamine.

26. (canceled)

27. The method according to claim 15, wherein the crosslinking bonds are sulfur-sulfur bonds that dissociate at temperatures greater than 50° C.

28. The method according to claim 15, wherein the one or more monomers comprise at least one member selected from the group consisting of ethylene, propylene, 1-butylene, 1-pentene, 1-hexene, 1-heptene, 1-octene, and vinyl acetate.

29. (canceled)

30. A reversibly-crosslinkable polymer, comprising the reaction product of the polymerizable composition of claim 1, wherein the reversibly-crosslinkable polymer contains a —S—S- moiety.

31. A reversibly-crosslinkable polymer obtained according to the method of claim 15.

32. The reversibly-crosslinkable polymer of claim 31, wherein the crosslinker is incorporated into the reversibly-crosslinkable polymer at an amount of from about 0.01 wt % to about 50 wt %, relative to 100 wt % of the total amount of the reversibly-crosslinkable polymer.
